(19) United States
(12) Patent Application Publication
(10) Pub. No.: US 2006/0233336 A1
(43) Pub. Date: Oct. 19, 2006

(54) Dialing methods and systems, and related devices

(75) Inventor: Hagihara Tadanori, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Incorporation

(21) Appl. No.: 11/107,578

(22) Filed: Apr. 15, 2005

(51) Int. Cl. H04M 15/06

(52) U.S. Cl. 379/142.06

(57) ABSTRACT

Dialing methods. A page of data is read. The page of data is parsed to obtain at least one set of numerals having a specific format. The set of numerals is set to be selectable in the page. The set of numerals is selected for dialing accordingly.

### BACKGROUND

The present disclosure relates generally to dialing methods and systems, and more particularly, to dialing methods and systems that recognize phone numbers in a page and dial accordingly, and related apparatuses and devices.

Nowadays, content services are widely provided on Web pages through networks. Devices, such as computer systems and portable devices with network capabilities, can connect to a network and read web pages via a browser thereof. For example, a user can wirelessly browse a web page describing restaurants by a mobile phone.

To make a call to reserve a table at a restaurant, typically, people need to record the phone number listed on the web page first, and then switch to a dial function of the mobile phone to input the phone number manually.

WTA (Wireless Telephony Application) of WAP (Wireless Application Protocol) provides a specific tag similar to hyperlinks in HTML (HyperText Markup Language). When creating or editing a web page, the content provider can mark the phone number with the specific tag so that the number will be selectable. When the phone number link is selected, users can dial the number directly. WTA, however, is not popular, and is not supported in most devices. Additionally, it is time-consuming to modify existing web pages. Moreover, conventional dialing practices are inconvenient.

### SUMMARY

Dialing methods and systems, and related apparatuses and devices are provided. In an exemplary embodiment of a dialing method, a page of data is read. The page of data is parsed to obtain at least one set of numerals having a specific format. The set of numerals is set to be selectable in the page. The set of numerals is selected for dialing accordingly.

An exemplary embodiment of a dialing system comprises a browser, a parser, and a processing module. The browser reads a page of data. The parser parses the page of data to obtain at least one set of numerals having a specific format. The processing module coupled to the parser to set the set of numerals to be selectable in the page. The set of numerals is selected for dialing accordingly.

An exemplary embodiment of an apparatus for providing a set of numerals for a dialing module comprises a parser and a processing module. The parser parses a page of data read from a browser to obtain at least one set of numerals having a specific format. The processing module coupled to the parser to determine whether the set of numerals is dialable. If dialable, the processing module sets the set of numerals to be selectable in the page. The set of numerals is selected for dialing by the dialing module.

Dialing methods and systems may take the form of program code embodied in a tangible media. When the program code is loaded into and executed by a machine, the machine becomes an apparatus for practicing the disclosed method.

### DESCRIPTION OF THE DRAWINGS

The invention will become more fully understood by referring to the following detailed description with reference to the accompanying drawings, wherein:

FIG. 1 is a schematic diagram illustrating an embodiment of a dialing system;

FIG. 2 is a flowchart showing an embodiment of a dialing method;

FIG. 3 is an example showing a web page;

FIG. 4 is an example showing source code for the web page in FIG. 3;

FIG. 5 is a flowchart showing an embodiment of a dialing method; and

FIG. 6 is a schematic diagram illustrating an embodiment of a storage medium storing a computer program for execution of a dialing method.

### DESCRIPTION

Dialing methods and systems, and related apparatuses and devices are provided.

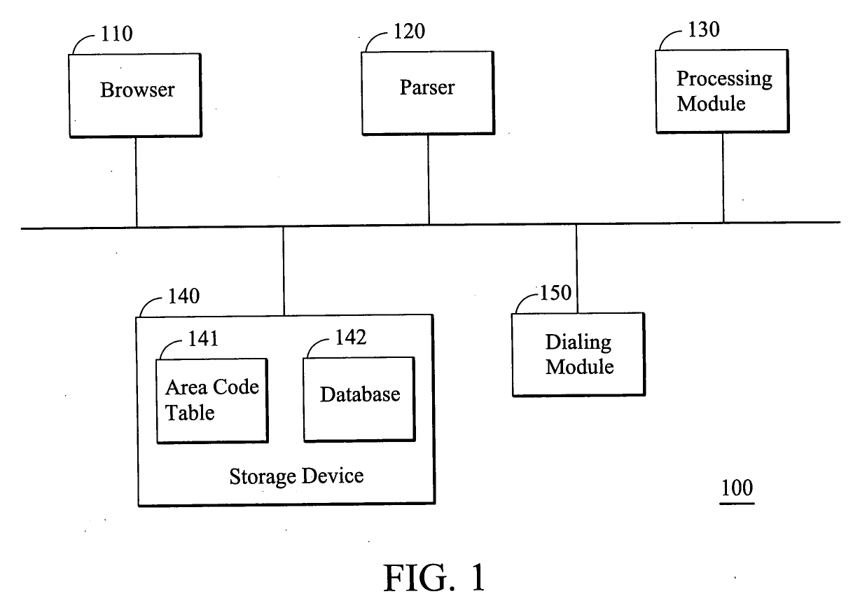

FIG. 1 is a schematic diagram illustrating an embodiment of a dialing system. The dialing system 100 comprises a browser 110, a parser 120, a processing module 130, a storage device 140, and a dialing module 150. The browser 110 reads pages of data, such as web pages. In some embodiments, the dialing system 100 is a portable device, such as a mobile phone and a smart phone. In some embodiments, the parser 120 and the processing module 130 can be implemented in to an apparatus, such as a chip. The dialing system 100 connects to the network and uses the browser 110 to read web pages wirelessly. The browser 110 can set at least a character in the page to be selectable. The parser 120 parses the page of data to obtain at least one set of numerals having a specific format. The storage device 140 comprises a database 142 recording acceptable phone number formats. Each set of numerals includes one or more digits. In some embodiments, the parser 120 searches data in the page for a set of numerals with a specific length. The specific length is ranged from 7 digits to 10 digits, conforming to the phone number formats recorded in the database 142. It should be noted that the phone number formats recorded in the database 142 can be set by users according to different countries or different service providers. After parsing the numerals, the processing module 130 then sets the set of numerals to be selectable in the page. In some embodiments, the selectable numerals could be highlighted or underlined or presented by different colors. While the set of numerals is selected for dialing, with instructions from the processing unit 130, the dialing module 150 dials the selected set of numerals.

Table 1 is an example showing an area code table 141. In table 1, each area name corresponds to an area code.

TABLE 1

| Area Name | Area Code |
|---|---|
| Taipei | 02 |
| Keelung | 02 |
| Taoyuan | 03 |
| Taichung | 04 |
| Kaoshiung | 07 |

The phone number formats may be regular expressions for possible phone numbers comprising fixed lines and mobile phones. For example, the regular expressions comprise “XXXX-XXXX”, “XXXXXXXX”, “XX-XXXX-XXXX”, “XX-XXXXXXXX”, “(XX)XXXX-XXXX”, “(XX)XXXXXXXX”, “0937XXXXXXX”, “0937-XXX-XXX”, and others, in which “X” represents an arbitrary number. It is understood that the regular expressions are flexible and dependent on telecommunication systems and user behavior.

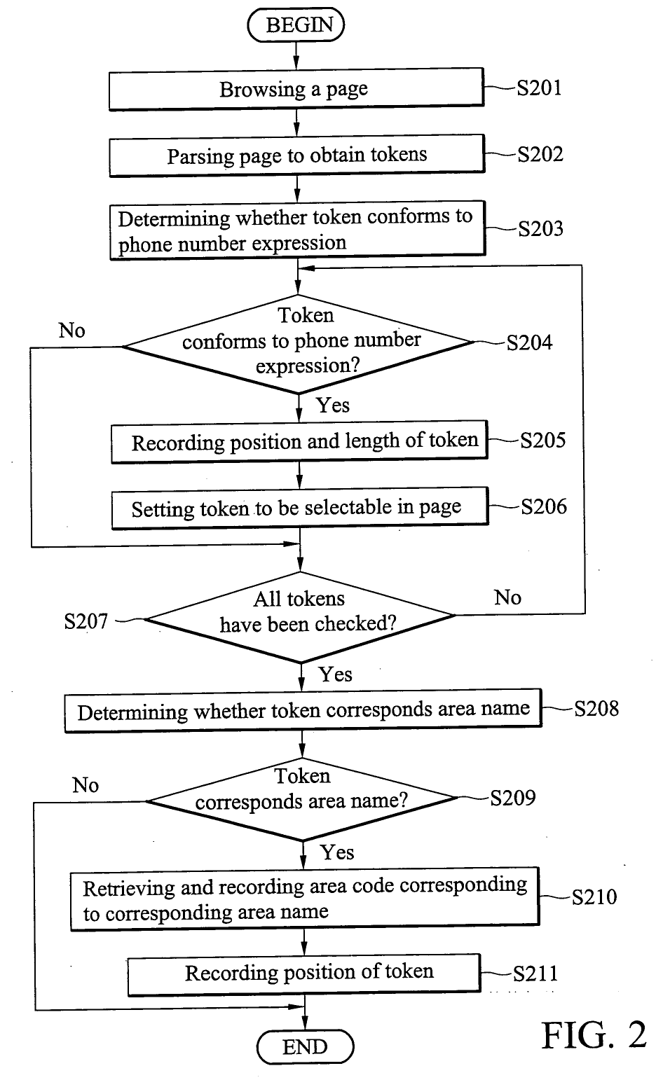

FIG. 2 is a flowchart showing-an embodiment of a dialing method. In this stage, the content of a page is analyzed to find phone numbers and area names.

In step S201, a page of data is read using the browser 110. In step S202, the parser 120 parses the page to obtain a plurality of tokens. It is understood that the tokens may be sets of numerals, sets of characters, and others. In step S203, it is determined whether respective tokens conform to the phone number formats in the database 142. If so (Yes in step S204), in step S205, the position and length of the conforming token are recorded. It is understood that if a token conforms to the phone number formats, the token is a set of numerals. In step S206, the browser 110 sets the conforming token to be selectable in the page according to the position and length thereof. If not (No in step S204), in step S207, it is determined whether all of the tokens have been checked. If so (Yes in step S207), the procedure goes to step S208. If not (No in step S207), the procedure returns to step S204 to locate other tokens.

In step S208, it is determined whether respective tokens correspond to the area names recorded in the area code table 141. In some embodiments, the corresponding relationship can be implemented by locating the respective area name from the page. If not (No in step S209), the procedure is completed. If so (Yes in step S209), in step S210, the area code corresponding to the corresponding area name is retrieved from the area code table 141 and recorded, and in step S211, the position of the corresponding token is recorded. It is understood that if a token corresponds to the area names, the token is a set of characters.

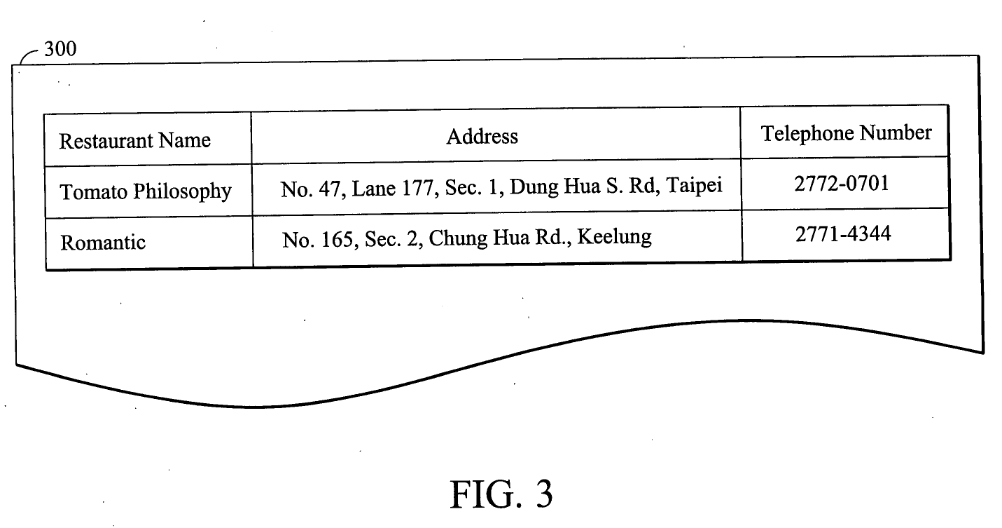

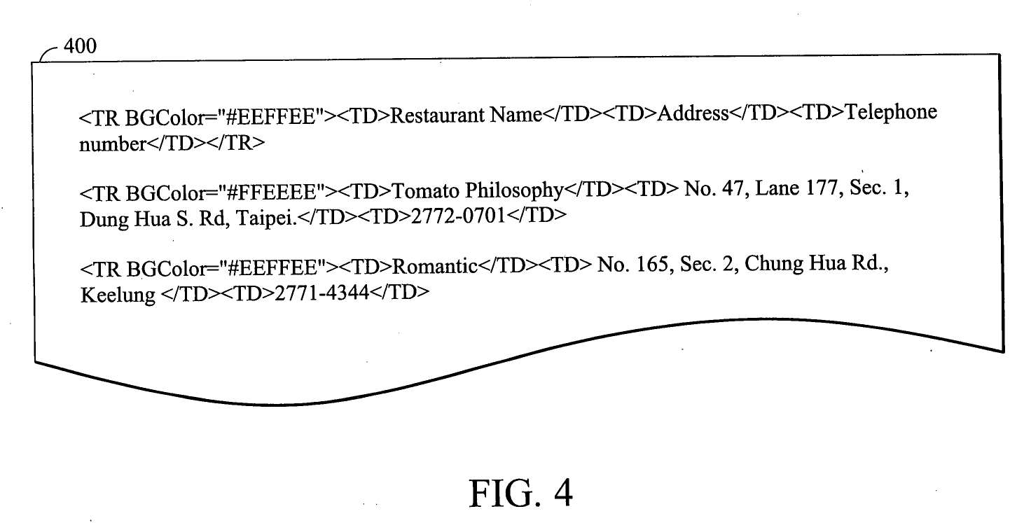

FIG. 3 is an example showing a web page 300. As shown in FIG. 3, the webpage 300 contains names, addresses, and telephone numbers of two restaurants. FIG. 4 is an example showing source codes 400 for the web page in FIG. 3. After the web page 300 is parsed and analyzed using the phone number formats in the database 142, the set of numerals “2772-0701” and “2771-4344” are recognized as phone numbers. The corresponding position comprising column and row and length of each set of numerals in the web page 300 is recorded, as show in Table 2.

TABLE 2

| | | | | | Is Mobile |
|---|---|---|---|---|---|
| Telephone | | | | With Area | Phone |
| Number | Column | Row | Length | Code | Number |
| 27720701 | 112 | 2 | 9 | No | No |
| 27714344 | 94 | 3 | 9 | No | No |

It is further determined whether the set of numerals comprises an area code, and whether the set of numerals conforms to a mobile phone format. The corresponding result can be also recorded, as shown in Table 2. After these sets of numerals “2772-0701” and “2771-4344” are recognized as phone numbers, the sets of numerals “2772-0701” and “2771-4344” are respectively set to be selectable according to the position and length thereof. Once the sets of numerals are set to be selectable, a user can use direction keys to locate the sets of numerals. The located set of numerals is highlighted. When a predetermined key, such as dialing key is pressed, a call is dialed according to the highlighted set of numerals.

Additionally, after the tokens of the web page 300 are compared with the area names in the area code table 141, the corresponding token and position thereof is recoded, as shown in Table 3.

TABLE 3

| Area Name | Column | Row |
|---|---|---|
| Taipei | 96 | 2 |
| Keelung | 77 | 3 |

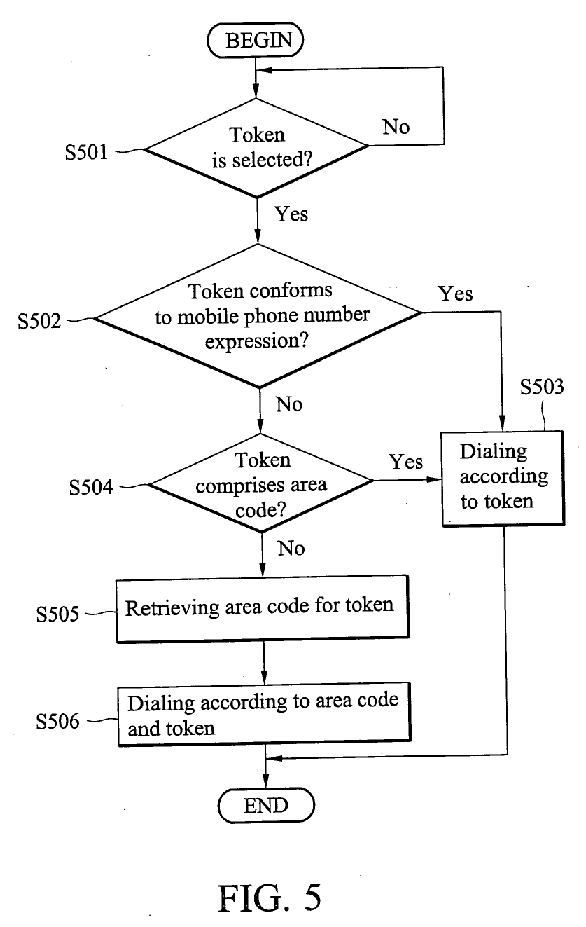

FIG. 5 is a flowchart showing an embodiment of a dialing method. In this stage, the validity of a phone number is determined, and the area code is automatically retrieved for the phone number.

In step S501, it is determined whether any token has been selected. If not (No in step S501), the procedure remains at step S501. If so (Yes in step S501), in step S502, it is determined whether the selected token conforms to the mobile phone format. If so (Yes in step S502), in step S503, a number is dialed according to the content of the token via the dialing module 150. If not (No in step S502), in step S504, it is determined whether the selected token comprises an area code. If so (Yes in step S504), in step S503, a number is dialed according to the content of the token. If not (No in step S504), in step S505, an area code is retrieved for the selected token, and in step S506, a number is dialed according to the area code and the token via the dialing module 150.

In some embodiments, the area code is retrieved according to a weighting between the selected token and each of the recorded tokens corresponding to a specific area name in the area code table 141. The weighting is based on the relative position of two tokens. In some embodiments, if the selected token and a token corresponding to a specific area name are in the same row, the area code corresponding to the area name is retrieved from the area code table 141 for the selected token, instead of the area code corresponding to another token corresponding to another specific area name in the different columns of the selected token. In some embodiments, a weighting formula is as follows:
W=abs(TT.C−AT.C)×A+abs(TT.R−AT.R)×B,
where TT.C is the column value of the selected token, AT.C is the column value of the token corresponding to a specific area name, TT.R is the row value of the selected token, AT.R is the row value of the token corresponding to a specific area name, and A and B are factors, in which B>>A.

After the weightings corresponding to respective area name are calculated, the area code corresponding to the area name having the lowest weighting is retrieved for the selected token. For example, if token “2772-0701” is selected, area code “02” corresponding to area name “Taipei” is retrieved, and a call is dialed according to the area code and the phone number of the selected token in table 2 (“0227720701”).

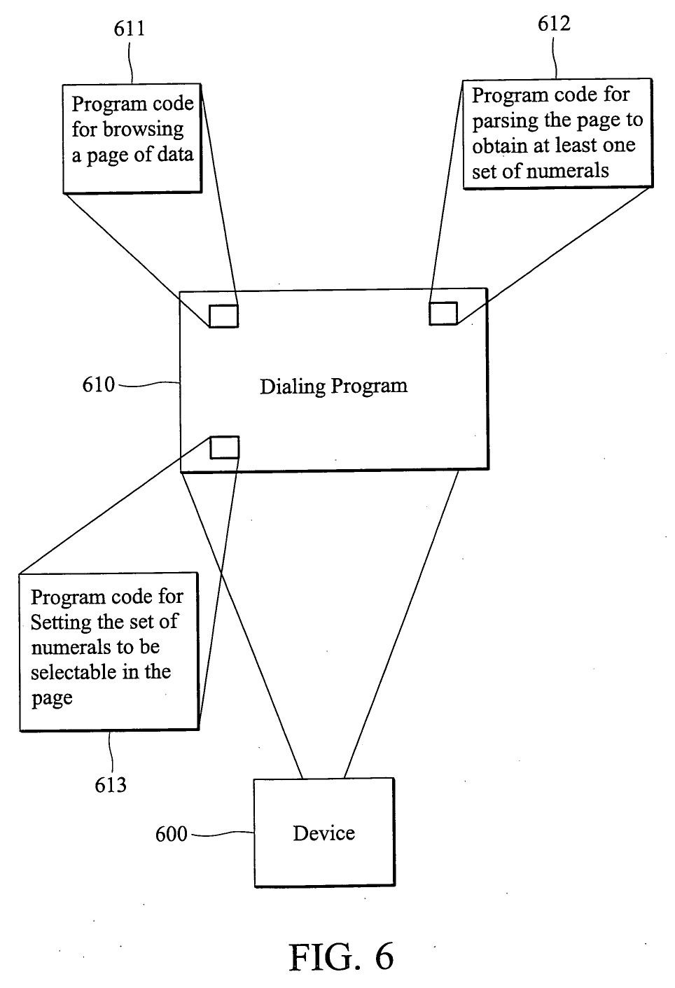

FIG. 6 is a schematic diagram illustrating an embodiment of a storage medium storing a computer program for execution of a dialing method. The computer program product comprises a storage medium 610 storing computer readable program codes for use in a device 600. The computer readable program code comprises at least computer readable program code 611 browsing a page of data, computer readable program code 612 parsing the page of data to obtain at least one set of numerals having a specific format, and computer readable program code 613 setting the set of numerals to be selectable in the page. The set of numerals is selected for dialing accordingly.

Dialing methods and systems, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer or a device comprising a mobile phone, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer or a device comprising a mobile phone, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A dialing method, comprising:
reading a page of data; parsing the page of data to obtain at least one set of numerals having a specific format; and
setting the set of numerals to be selectable in the page;
wherein the set of numerals is selected for dialing accordingly.

2. The method of claim 1, wherein the parsing step further comprising searching data in the page for a set of numerals with a specific length.

3. The method of claim 2, wherein the specific length is ranged from 7 digits to 10 digits.

4. The method of claim 1, wherein while one set of numerals is selected for dialing, the method further comprising:
determining whether the set of numerals is dialable; and
if not, parsing the page of data to obtain extra information;
wherein the set of numerals is dialed together with the extra information.

5. The method of claim 4, wherein the extra information is an area code.

6. The method of claim 5, wherein a database recording a plurality of area names and area codes is provided, the parsing step further comprising:
comparing data in the page with the area names recorded in the database;
determining whether at least one area name matches data in the page; and
retrieving the area code corresponding to the matched area name.

7. The method of claim 6, wherein the parsing step further comprising selecting one area name if more than one area name matches data in the page.

8. The method of claim 6, further comprising:
if more than one area name matches data in the page, respectively calculating a distance from the position of the data in the page that matches the area name to the selected set of numerals; and
selecting one of the matched area names according to the distance.

9. The method of claim 1 further comprising browsing the page via a network.

10. A dialing system, comprising:
a browser for reading a page of data;
a parser for parsing the page of data to obtain at least one set of numerals having a specific format; and
a processing module, coupled to the parser, for setting the set of numerals to be selectable in the page;
wherein the set of numerals is selected for dialing accordingly.

11. The system of claim 10, wherein the parser further searches data in the page for a set of numerals with a specific length.

12. The system of claim 11 wherein the specific length is ranged from 7 digits to 10 digits.

13. The system of claim 12 wherein while one set of numerals is selected for dialing, the processing module further determines whether the set of numerals is dialable; and if not, the parser again parses the page of data to obtain extra information; wherein the set of numerals is dialed together with the extra information.

14. The system of claim 13, wherein the extra information is an area code.

15. The system of claim 14, wherein the system further comprises a database recording a plurality of area names and area codes, the processing module compares data in the page with the area names recorded in the database and determines whether at least one area name matches data in the page, and if any, the processing module further retrieves the area code corresponding to the matched area name.

16. The system of claim 15, wherein the processing module further selects one of the area names if more than one area name matches data in the page.

17. The system of claim 15, wherein if more than one area name matches data in the page, the processing module further respectively calculates a distance from the position of the data in the page that matches the area name to the selected set of numerals, and selects one of the matched area names according to the distance.

18. The system of claim 10 wherein the browser further reads the page via a network.

19. An apparatus for providing a set of numerals for a dialing module, comprising:
a parser for parsing a page of data read from a browser to obtain at least one set of numerals having a specific format; and
a processing module, coupled to the parser, for determining whether the set of numerals is dialable, wherein if dialable, the processing module sets the set of numerals to be selectable in the page;
wherein the set of numerals is selected for dialing by the dialing module.

20. The apparatus of claim 19, wherein if the set of numerals is not dialable, the parser again parses the page of data to obtain extra information, wherein the dialing module dials the set of numerals together with the extra information.

21. The apparatus of claim 20, wherein the extra information is an area code.

22. The apparatus of claim 21, wherein a database recording a plurality of area names and area codes is provided, the processing module compares data in the page with the area names recorded in the database, and further determines whether at least one area name matches data in the page; and if any, the processing module further retrieves the area code corresponding to the matched area name.

23. The apparatus of claim 22, wherein the processing module further selects one of the area names if more than one area name matches data in the page.

24. The apparatus of claim 22, wherein if more than one area name matches data in the page, the processing module further respectively calculates a distance from the position of the data in the page that matches the area name to the selected set of numerals, and selects one of the matched area names according to the distance.

25. The apparatus of claim 19, wherein the apparatus is a chip.

26. A device, comprising:
means for browsing a page of data;
means for parsing the page of data to obtain at least one set of numerals having a specific format; and
means for setting the set of numerals to be selectable in the page;
wherein the set of numerals is selected for dialing accordingly.

27. A machine-readable storage medium comprising a computer program, which, when executed, causes a device to perform a dialing method, the method comprising:
browsing a page of data;
parsing the page of data to obtain at least one set of numerals having a specific format; and
setting the set of numerals to be selectable in the page;
wherein the set of numerals is selected for dialing accordingly.
